(19) United States
(12) Patent Application Publication
(10) Pub. No.: US 2024/0112831 A1
(43) Pub. Date: Apr. 4, 2024

(54) Submarine Power Cable With Slip Additive

(71) Applicant: NKT HV Cables AB, Lyckeby (SE)

(72) Inventors: Henrik Torvaldsson, Karlskrona (SE); Andreas Tyrberg, Lyckeby (SE); Tommy Johansson, Bräkne-Hoby (SE); Denny Tjahjanto, Sundbyberg (SE)

(21) Appl. No.: 18/474,632

(22) Filed: Sep. 26, 2023

(30) Foreign Application Priority Data
Sep. 30, 2022 (EP) 22199220.9

(51) Int. Cl. H01B 7/14; H01B 3/42; H01B 3/44

(52) U.S. Cl. CPC H01B 7/14; H01B 3/421; H01B 3/44

(57) ABSTRACT

A submarine power cable having: a plurality of elongated elements arranged in a stranded configuration, wherein at least two of the elongated elements are power cores, each power core including a conductor, an insulation system arranged around the conductor, and a polymeric sheath including a first polymeric material arranged around the insulation system, and a plurality of filler profiles including a second polymeric material, each filler profile being arranged in a respective interstice between two elongated elements of the plurality of elongated elements, wherein the first polymeric material and/or the second polymeric material includes a slip additive.

### TECHNICAL FIELD

The present disclosure generally relates to submarine power cables.

### BACKGROUND

Submarine power cables are subjected to movements when suspended from a floating structure to the seabed. This may for example be for a shorter period of time occur during cable laying, but also after installation in case the submarine power cable is a dynamic submarine power cable, i.e., a cable suspended from a floating platform to the seabed, and which is designed to withstand constant movement due to wave motion.

In general, the life expectancy of a dynamic submarine power cable from a mechanical perspective depends on how well the cable is able to distribute the stress during movement.

### SUMMARY

An object of the present disclosure is to provide a submarine power cable which solves or at least mitigates the problems of the prior art.

There is hence provided a submarine power cable comprising: a plurality of elongated elements arranged in a stranded configuration, wherein at least two of the elongated elements are power cores, each power core comprising a conductor, an insulation system arranged around the conductor, and a polymeric sheath comprising a first polymeric material arranged around the insulation system, and a plurality of filler profiles comprising a second polymeric material, each filler profile being arranged in a respective interstice between two elongated elements of the plurality of elongated elements, wherein the first polymeric material and/or the second polymeric material comprises a slip additive.

The slip additive lowers the surface friction coefficient between internal components in the submarine power cable, such as between the filler profiles and the polymeric sheaths of the power cores. This facilitates sliding of the filler profiles and/or power cores within the submarine power cable. Stresses due to movement of the submarine power cable as a result of wave motion, are therefore distributed in such a way that the strain on the power cores is minimised. The lifespan of the submarine power cable can thereby be increased.

The insulation system of each power core may be an extruded insulation system.

The filler profiles may be extruded filler profiles.

The submarine power cable may comprise two or more than two elongated elements.

The submarine power cable may comprise three power cores. Alternatively, the submarine power cable may comprise only two power cores.

The slip additive may comprise one or more components.

In case both the first polymeric material and the second polymeric material comprises a slip additive, the slip additive may be the same in both the first polymeric material and the second polymeric material. Alternatively, the slip additive contained in the first polymeric material may differ from the slip additive contained in the second polymeric material.

According to one embodiment the first polymeric material comprises the slip additive, the first polymeric material comprising the slip additive in a range of 0.01-5 wt. % of the total weight of the first polymeric material.

According to one embodiment the second polymeric material comprises the slip additive, the second polymeric material comprising the slip additive in a range of 0.01-5 wt. % of the total weight of the second polymeric material.

According to one embodiment the slip additive comprises an amide.

According to one embodiment the amide is erucamide or oleamide.

The first polymeric material may comprise erucamide or oleamide in a range of 0.01-0.3 wt. %, such as in a range of 0.02-0.2 wt. % of the total weight of the first polymeric material.

The second polymeric material may comprise erucamide or oleamide in a range of 0.01-0.3 wt. %, such as in a range of 0.02-0.2 wt. % of the total weight of the second polymeric material.

The amide may according to one example be Ethylene bis(stearamide).

According to one embodiment the slip additive comprises talc. A combination of erucamide or oleamide and talc as slip additive has shown to be synergistic because the friction coefficient of the polymeric material becomes lower than if using only one of erucamide, oleamide, or talc as a slip additive.

According to one embodiment the first polymeric material comprises polyethylene such as low density, medium density, or high density polyethylene, polypropylene, polyamide, a polyester-based material, or polyvinylchloride.

According to one embodiment the second polymeric material comprises polyethylene such as low density, medium density or high density polyethylene, polypropylene, polyamide, a polyester-based material, or polyvinylchloride.

According to one embodiment each power core comprises a metallic water blocking layer, wherein the polymeric sheath is arranged radially outside the metallic water blocking layer.

One embodiment comprises a first bedding layer enclosing the plurality of elongated elements, wherein the first bedding layer comprises a third polymeric material comprising a slip additive.

The first bedding layer may be an armour first bedding layer.

According to one example the slip additive contained in the third polymeric material may be in a range of 0.01-5 wt. % of the total weight of the third polymeric material.

According to one example the slip additive contained in the third polymeric material comprises an amide.

According to one example the amide contained in the third polymeric material is erucamide or oleamide.

The third polymeric material may comprise erucamide or oleamide in a range of 0.01-0.3 wt. %, such as in a range of 0.02-0.2 wt. % of the total weight of the third polymeric material.

1.5 According to one example the slip additive contained in the third polymeric material comprises talc.

According to one embodiment the third polymeric material comprises polyethylene, polypropylene, polyamide, a polyester-based material, or polyvinylchloride.

One embodiment comprises: an armour layer arranged around the first bedding layer, a second bedding layer arranged around the armour layer, and a second armour layer arranged around the second bedding layer, wherein the second bedding layer comprises a fourth polymeric material comprising a slip additive.

According to one embodiment the fourth polymeric material comprises polyethylene, polypropylene, polyamide, a polyester-based material, or polyvinylchloride.

According to one example the slip additive contained in the fourth polymeric material may be in a range of 0.01-5 wt. % of the total weight of the third polymeric material.

According to one example the slip additive contained in the fourth polymeric material comprises an amide.

According to one example the amide contained in the fourth polymeric material is erucamide or oleamide.

The fourth polymeric material may comprise erucamide or oleamide in a range of 0.01-0.3 wt. %, such as in a range of 0.02-0.2 wt. % of the total weight of the third polymeric material.

According to one example the slip additive contained in the fourth polymeric material comprises talc.

According to one embodiment each power core is in direct contact with two of the filler profiles.

According to one embodiment the submarine power cable is a dynamic submarine power cable.

The submarine power cable may be a medium voltage or a high voltage submarine power cable.

The submarine power cable may be an AC submarine power cable or a DC submarine power cable.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a cross-sectional view of an example of a submarine power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

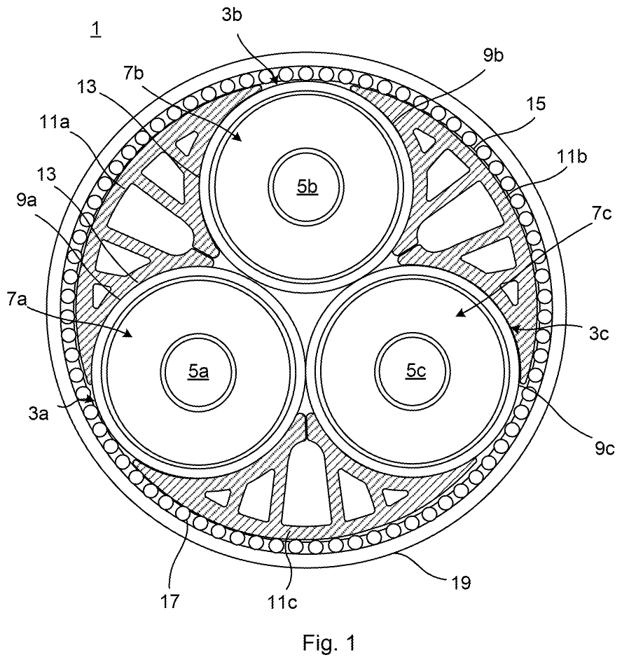

FIG. 1 shows a cross section of an example of a submarine power cable 1. The submarine power cable 1 comprises three elongated elements arranged in a stranded configuration. According to the example, each elongated element is a power core 3a-3c. The power cores 3a, 3b, and 3c are thus stranded.

The power cores 3a-3c may be AC power cores or DC power cores.

Alternatively, two of the elongated elements may be power cores, while one of the three elongated elements may be a dummy element having essentially the same diameter as the power cores, e.g., within plus/minus 10% of the diameter of each power core, or the same diameter as each power core.

Each power core 3a, 3b, 3c comprises a respective conductor 5a, 5b, 5c, a respective insulation system 7a, 7b, 7c arranged around the conductor 5a, 5b, 5c, and a respective polymeric sheath 9a, 9b, 9c arranged around the insulation system 7a, 7b, 7c.

Each insulation system 7a, 7b, 7c comprises a respective inner semiconducting layer arranged around the conductor 5a, 5b, 5c, an insulation layer arranged around the inner semiconducting layer, and an outer semiconducting layer arranged around the insulation layer.

The insulation system 7a, 7b, 7c may for example be an extruded insulation system, or a paper-based oil-impregnated insulation system.

The polymeric sheath 9a, 9b, 9c is made of a first polymeric material. The first polymeric material may for example comprise polyethylene such as low density, medium density, or high density polyethylene, polypropylene, polyamide, a polyester-based material, or polyvinylchloride.

Each power core 3a, 3b, 3c may optionally comprise a respective metallic water blocking layer, arranged between the outer semiconducting layer and the polymeric sheath 9a, 9b, 9c. The metallic water blocking layer may for example comprise lead, copper, aluminium, or steel such as stainless steel. The metallic water blocking layer may be corrugated or smooth.

The submarine power cable 1 comprises a plurality of filler profiles 11a-11c. In particular, the submarine power cable 1 comprises three filler profiles 11a-11c. Each filler profile 11a, 11b, 11c is arranged in an interstice between two adjacent power cores 3a, 3b, 3c. The filler profiles 11a-11c are stranded together with the power cores 3a-3c.

The submarine power cable 1 may comprise a binder layer arranged around the stranded power cores 3a-3c and the stranded filler profiles 11a-11c. The binder layer may for example be formed of tape. The binder layer holds the power cores 3a-3c and the filler profiles 11a-11c together in the stranded configuration. Especially, the binder layer holds the stranded power cores 3a-3c and stranded filler profiles 11a-11c together in the production line in the stranding process, before any additional layer has been provided around the stranded power cores 3a-3c and filler profiles 11a-11c.

Each filler profile 11a-11c has two inner curved surfaces 13. Each inner curved surface 13 is configured to partly receive and bear against the polymeric sheath 9a, 9b, 9c of one power core 3a-3c. Each filler profile 11a-11c is thus in direct contact with two power cores 3a-3c.

The filler profiles 11a-11c are made of a second polymeric material. The second polymeric material may for example comprise polyethylene such as low density, medium density or high density polyethylene, polypropylene, polyamide, a polyester-based material, or polyvinylchloride.

The first polymeric material may comprise a slip additive. Alternatively, or additionally, the second polymeric material may comprise a slip additive.

The slip additive may be a migrating slip additive. A portion of the slip additive has thus migrated to the surface of the polymeric material in which it is contained, i.e., in the first polymeric material and/or the second polymeric material to reduce the friction coefficient of the outer surface of the polymeric material(s).

In case the first polymeric material comprises a slip additive, the first polymeric material may comprise the slip additive in a range of 0.01-5 wt. % of the total weight of the first polymeric material.

In case the second polymeric material comprises a slip additive, the second polymeric material may comprise the slip additive in a range of 0.01-5 wt. % of the total weight of the second polymeric material.

The slip additive used in any of the polymeric materials may comprise an amide such as erucamide or oleamide.

The slip additive used in any of the polymeric material may according to one example comprise talc.

The slip additive may be added to the base polymer before or while extruding the polymeric sheaths 9a-9c and/or the filler profiles 11a-11c.

According to one example, the submarine power cable 1 comprises a first bedding layer 15 arranged around the plurality of elongated elements and filler profiles 11a-11c. The first bedding layer 15 may be arranged around the binder layer. The first bedding layer 15 may for example be an extruded polymeric sheath or it may be formed of a plurality of polymeric yarns wound helically around the binder layer along the longitudinal direction of the submarine power cable 1.

According to one example, the first bedding layer 15 comprises a third polymeric material comprising a slip additive. The slip additive may be the same slip additive as used in the first polymeric material and/or in the second polymeric material. Portions of the first bedding layer 15 may be in direct contact with the filler profiles 11a-11c and/or the elongated elements/power cores 3a-3c, in regions where no binder layer is present.

The submarine power cable 1 may comprise an armour layer comprising a plurality of armour wires 17 arranged around the first bedding layer 15.

According to one example, the submarine power cable 1 may comprise a second bedding layer arranged around the armour layer, and a second armour layer arranged around the second bedding layer. The second bedding layer comprises a fourth polymeric material comprising a slip additive. The slip additive may be the same slip additive as used in the first polymeric material and/or in the second polymeric material

The submarine power cable 1 comprises an outer sheath or outer serving 19. The outer sheath may be an extruded polymer layer. The outer serving may be formed of a plurality of polymeric yarns arranged helically in the longitudinal direction of the submarine power cable 1.

The submarine power cable 1 may comprise additional layer(s), e.g., each power core may comprise one or more water swellable tape layer(s), and/or a screen layer.

The inventive concept has mainly been described above with reference to a few examples. However, as is readily appreciated by a person skilled in the art, other embodiments than the ones disclosed above are equally possible within the scope of the inventive concept, as defined by the appended claims.

1. A submarine power cable comprising:
a plurality elongated elements arranged in a stranded configuration, wherein at least two of the elongated elements are power cores, each power core having a conductor, an insulation system arranged around the conductor, and a polymeric sheath including a first polymeric material arranged around the insulation system, and
a plurality of filler profiles including a second polymeric material, each filler profile being arranged in a respective interstice between two elongated elements of the plurality of elongated elements,
wherein the first polymeric material and/or the second polymeric material includes a slip additive.

2. The submarine power cable as claimed in claim 1, wherein the first polymeric material comprises the slip additive, the first polymeric material including the slip additive in a range of 0.01-5 wt. % of the total weight of the first polymeric material.

3. The submarine power cable as claimed in claim 1, wherein the second polymeric material comprises the slip additive, the second polymeric material including the slip additive in a range of 0.01-5 wt. % of the total weight of the second polymeric material.

4. The submarine power cable as claimed in claim 1, wherein the slip additive comprises an amide.

5. The submarine power cable as claimed in claim 4, wherein the amide is erucamide or oleamide.

6. The submarine power cable as claimed in claim 4, wherein the slip additive comprises talc.

7. The submarine power cable as claimed in claim 1, wherein the first polymeric material comprises polyethylene such as low density, medium density, or high density polyethylene, polypropylene, polyamide, or polyester-based material, or polyvinylchloride.

8. The submarine power cable as claimed in claim 1, wherein the second polymeric material comprises polyethylene such as low density, medium density or high density polyethylene, polypropylene, polyamide, a polyester-based material, or polyvinylchloride.

9. The submarine power cable as claimed in claim 1, wherein each power core comprises a metallic water blocking layer, wherein the polymeric sheath is arranged radially outside the metallic water blocking layer.

10. The submarine power cable as claimed in claim 1, comprising a first bedding layer enclosing the plurality of elongated elements, wherein the first bedding layer includes a third polymeric material having a slip additive.

11. The submarine power cable as claimed in claim 10, wherein the third polymeric material comprises polyethylene, polypropylene, polyamide, a polyester-based material, or polyvinylchloride.

12. The submarine power cable as claimed in claim comprising: an armour layer arranged around the first bedding layer, a second bedding layer arranged around the armour layer, and a second armour layer arranged around the second bedding layer, wherein the second bedding layer includes a fourth polymeric material having a slip additive.

13. The submarine power cable as claimed in claim 12, wherein the fourth polymeric material comprises polyethylene, polypropylene, polyamide, a polyester-based material, or polyvinylchloride.

14. The submarine power cable as claimed in claim 1, wherein each power core is in direct contact with two of the filler profiles.

15. The submarine power cable as claimed in claim 1, wherein the submarine power cable is a dynamic submarine power cable.

16. The submarine power cable as claimed in claim 1, wherein the second polymeric material comprises the slip additive, the second polymeric material including the slip additive in a range of 0.01-5 wt. % of the total weight of the second polymeric material.

17. The submarine power cable as claimed in claim 2, wherein the slip additive comprises an amide.

18. The submarine power cable as claimed in claim 2, wherein the first polymeric material comprises polyethylene such as low density, medium density, or high density polyethylene, polypropylene, polyamide, or polyester-based material, or polyvinylchloride.

19. The submarine power cable as claimed in claim 2, wherein the second polymeric material comprises polyethylene such as low density, medium density or high density polyethylene, polypropylene, polyamide, a polyester-based material, or polyvinylchloride.

20. The submarine power cable as claimed in claim 2, wherein each power core comprises a metallic water blocking layer, wherein the polymeric sheath is arranged radially outside the metallic water blocking layer.
